(19) United States
(12) Patent Application Publication
(10) Pub. No.: US 2019/0034785 A1
(43) Pub. Date: Jan. 31, 2019

(54) SYSTEM AND METHOD FOR PROGRAM INDUCTION USING PROBABILISTIC NEURAL PROGRAMS

(71) Applicant: The Allen Institute for Artificial Intelligence, Seattle, WA (US)

(72) Inventors: Kenton W. Murray, South Bend, IN (US); Jayant Krishnamurthy, Seattle, WA (US)

(21) Appl. No.: 16/044,220

(22) Filed: Jul. 24, 2018

Related U.S. Application Data
(60) Provisional application No. 62/536,881, filed on Jul. 25, 2017.

(51) Int. Cl. G06N 3/04; G06N 7/00; G06N 5/04; G06N 99/00; G06F 9/30

(52) U.S. Cl. CPC G06N 3/0454; G06N 7/005; G06F 9/30003; G06N 99/005; G06N 5/04

(57) ABSTRACT

Embodiments are directed to probabilistic neural programs, a framework for program induction that permits flexible specification of the computational model and inference algorithm, while simultaneously enabling the use of deep neural networks. The approach implemented by one or more embodiments builds on computation graph frameworks for specifying neural networks by adding an operator for weighted nondeterministic choice that is used to specify the computational model. Thus, a program sketch describes both the decisions to be made and the architecture of the neural network used to score these decisions. The computation graph interacts with nondeterminism: the scores produced by the neural network determine the weights of nondeterministic choices, while the choices determine the network's architecture.

### CROSS REFERENCE TO RELATED APPLICATION

This application claims the benefit of U.S. Provisional Application No. 62/536,881, entitled “System and Method for Program Induction Using Probabilistic Neural Programs,” Jul. 25, 2017, which is incorporated herein by reference in its entirety (including the appendix) for all purposes.

### BACKGROUND

Inductive programming (IP) is an area of the broader field of automated computer programming, and includes research from both artificial intelligence and conventional computer programming disciplines. In a sense, inductive programming addresses the learning tasks needed for the development of declarative (in terms of logic or functionality) and often recursive programs from incomplete specifications.

Prior work on program induction has described two general classes of approaches. First, in a noise-free setting, program synthesis approaches pose the task of program induction as completing a program “sketch,” which is a program form containing nondeterministic choices (“holes”), where the choice selected is specified by a learning algorithm. Probabilistic programming languages generalize this approach to a noisy setting by permitting the sketch to specify a distribution over these choices, where the distribution is a function of prior parameters. Further, the distribution may be conditioned on data, thereby training a Bayesian generative model to execute the program sketch correctly.

In a second general approach to program induction, neural abstract machines define continuous analogues of Turing machines or other general-purpose computational models by transferring their discrete state and computation rules into a continuous representation.

However, while both of these conventional approaches have demonstrated some success at inducing simple programs from synthetic data, they have yet to be applied to practical (and typically more complex) problems. Embodiments of the invention are directed toward solving these and other problems individually and collectively.

### SUMMARY

The terms “invention,” “the invention,” “this invention” and “the present invention” as used herein are intended to refer broadly to all of the subject matter described in this document and to the claims. Statements containing these terms should be understood to not limit the subject matter described herein or to limit the meaning or scope of the claims. Embodiments of the invention are defined by the claims and not by this summary. This summary is a high-level overview of various aspects of the invention and introduces some of the concepts that are further described in the Detailed Description section below. This summary is not intended to identify key, required or essential features of the claimed subject matter, nor is it intended to be used in isolation to determine the scope of the claimed subject matter. The subject matter should be understood by reference to appropriate portions of the entire specification of this patent, to any or all drawings, and to each claim.

In one embodiment, the invention is directed to a method for generating a computation graph describing a computation, where the method includes:
representing the computation by a set of graph nodes and edges, wherein each graph node is associated with a corresponding value and each edge represents a relationship between a pair of nodes;
using an operator to determine a value in the computation graph, wherein the operator performs a nondeterministic operation that is implemented at least in part by a neural network; and
storing a representation of the computation graph in an electronic data storage element.

In another embodiment, the invention is directed to an apparatus for generating a computation graph for a computation, where the apparatus includes:
a processor programmed to execute a set of instructions;
a data storage element in which the set of instructions are stored, wherein when executed by the processor the set of instructions cause the apparatus to
   represent the computation by a set of graph nodes and edges, wherein each graph node is associated with a corresponding value and each edge represents a relationship between a pair of nodes;
   use an operator to determine a value in the computation graph, wherein the operator performs a nondeterministic operation that is implemented at least in part by a neural network; and
   store a representation of the computation graph in an electronic data storage element.

Other objects and advantages will be apparent to one of ordinary skill in the art upon review of the detailed description and the included figures.

### BRIEF DESCRIPTION OF THE DRAWINGS

Embodiments in accordance with the present disclosure will be described with reference to the drawings, in which:

FIG. 1 is a diagram illustrating a multilayer perceptron defined as a probabilistic neural program;

FIG. 2 is a diagram illustrating a food web with annotations generated from a computer vision system (left) along with related questions and their associated program sketches (right), and represents an example problem or task to which the inventive approach has been applied;

FIG. 3 is a diagram illustrating elements or components that may be present in a computer device or system configured to implement a method, process, function, or operation in accordance with an embodiment described herein; and

FIG. 4 is a flowchart or flow diagram illustrating a process, method, or sequence of operations for implementing an embodiment of the inventive system and method.

Note that the same numbers are used throughout the disclosure and figures to reference like components and features.

### DETAILED DESCRIPTION

The subject matter of embodiments are described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the invention may be practiced. The invention may, however, be embodied in many different forms and should not be construed as limited to the embodiments set forth herein; rather, these embodiments are provided so that this disclosure will satisfy the statutory requirements and convey the scope of the invention to those skilled in the art. Accordingly, embodiments are not limited to the embodiments described herein or depicted in the drawings, and various embodiments and modifications can be made without departing from the scope of the claims presented.

As mentioned, Inductive programming (IP) is an area of the broader field of automated computer programming, and includes research from both artificial intelligence and conventional computer programming disciplines. In a sense, inductive programming addresses the learning tasks needed for the development of declarative (in terms of logic or functionality) and often recursive programs from incomplete specifications. In some cases, the incomplete specification of the program may result from having limited input/output examples or may arise from the presence of constraints. Depending on the programming language used, there are several categories of inductive programming. These include inductive functional programming (which uses functional programming languages such as Lisp or Haskell), and inductive logic programming (which uses logic programming languages such as Prolog and/or other logical representations, such as description logics). Other (programming) language paradigms have also been used, such as constraint programming or probabilistic programming.

In a general sense, Inductive Programming incorporates approaches concerned with learning programs or algorithms from incomplete (formal) specifications. Possible inputs to an inductive programming system are a set of training inputs and corresponding outputs or an output evaluation function (describing the desired behavior of the intended program). Other possible inputs include: traces or action sequences which describe the process of calculating specific outputs; constraints for the program concerning its time efficiency or its complexity; relevant background knowledge such as standard data types; predefined functions to be used; program schemes or templates describing the data flow of the intended program; or, heuristics for guiding the search for a solution or other biases.

The desired output of an inductive programming system is a program in a programming language containing conditionals and loop or recursive control structures, or any other kind of Turing-complete representation language. In many applications, the output program must be “correct” with respect to the examples and partial specification, and this leads to the consideration of inductive programming as a special area within automated programming or program synthesis, as opposed to “deductive” program synthesis where the specification is usually complete.

In some cases, inductive programming is viewed as a more general area where any declarative programming or representation language can be used, and some degree of error in the examples may be accepted, as in general machine learning or the area of symbolic artificial intelligence. However, a distinctive feature of inductive programming is the number of examples or the degree of the “partial” specification needed. Typically, inductive programming techniques can learn from a relatively few examples, as the search space is usually defined to be rather small. The diversity/variety of programs learned from inductive programming typically arises from the applications and the languages that are used.

Apart from logic programming and functional programming, other programming paradigms and representation languages have been used (or suggested for use) in inductive programming; these include functional logic programming, constraint programming, probabilistic programming, abductive logic programming (a form of logical inference which starts with an observation and seeks to find the simplest and most likely explanation for that observation), modal logic, action languages, agent languages and imperative languages.

As observed by the inventors, there are (at least) three dimensions or aspects which may be used to characterize conventional program induction approaches:

1. Computational Model—what abstract model of computation does the model learn to emulate or control? (e.g., a Turing machine);

2. Learning Mechanism—what kinds of machine learning models are supported?(e.g., neural networks, Bayesian generative models); and

3. Inference—how does the approach reason or decide about the many possible executions or execution paths of the machine?

As recognized by the inventors, neural abstract machines conflate some of these dimensions: they naturally support deep learning, but commit to a particular computational model and approximate inference algorithm. These choices are suboptimal as (1) the bias/variance trade-off suggests that training a more expressive computational model will require more data than a less expressive one suited to the task at hand; and (2) recent work has suggested that discrete inference algorithms may outperform continuous approximations for some applications.

In contrast, probabilistic programming supports the specification of different (and possibly task-specific) computational models and inference algorithms, including discrete search and continuous approximations. However, these languages are restricted to generative models and cannot leverage the power of deep neural networks.

This suggests that neither neural abstract machines nor probabilistic programming approaches provide an optimal solution to the problem of needing a flexible and comprehensive approach to inductive programming that can leverage the advantages of deep learning models while enabling the use of a wider variety of computational models and inference algorithms (including non-determinative inference algorithms).

In recent years, deep learning has produced significant accuracy improvements for a variety of tasks in computer vision and natural language processing. As recognized by the inventors, a natural next step for deep learning is to consider program induction, characterized as the problem of learning/developing computer programs from (noisy) input/output examples. Compared to more traditional problems such as object recognition or classification (that require making only a single decision), program induction is more difficult because it requires making a sequence of decisions and possibly needing to learn program flow control concepts such as loops and if-then statements.

Embodiments or implementations of the approach(es) described herein may be used to generate a program or process for making a decision that is derived at least in part from data or other outputs produced by a neural network. The program or process may be specified by a computation graph, which is a form of representing a computation or computing program by the data flow (e.g., expressed as data tensors) through a series of operations (indicated by nodes in the graph). The operations or graph nodes include an operator, where the operator is used to make a nondeterministic choice that influences the program logic. The combination of a computation graph and the operator represents a collection of decisions and information about the computing architecture used to make each decision. The computation graph describes how a program will execute or how a neural network will operate to process an input. A computation graph structure is typically described in terms of the following aspects:

a node is (or has) a value (e.g., tensor, matrix, vector, scalar);

an edge represents a function argument (and also data dependency)—in this way, edges are pointers to nodes; and

a node with an incoming edge is a function of that edge's tail node.

Some of the embodiments described herein are directed to systems, apparatuses, and methods for more efficiently implementing an inductive programming model for developing software. In some embodiments, the invention is directed to a framework for program induction that permits flexible specification of the computational model and inference algorithm while simultaneously enabling the use of deep neural networks. In some embodiments, the approach described herein modifies conventional computation graph frameworks for specifying neural networks by adding an operator for performing a weighted, nondeterministic choice, where the operator is used to specify the computational model. Thus, a program “sketch” developed using such an embodiment describes both the decisions to be made and the architecture of the neural network used to “score” or otherwise evaluate those decisions (e.g., by specifying a computational model, loss function, or other parameter or characteristic).

In some embodiments, the approach(es) described herein may be used to implement one or more of the operations, functions, processes, or methods used in the development of a neural network, the application of a machine learning technique or techniques, or the development or implementation of an appropriate computation algorithm, model or decision process. Note that in some cases, a neural network or deep learning model may be characterized as a form of data structure in which a set of layers and connections are created or formed that operate on an input to provide a decision as an output.

In some embodiments or implementations, the computation graph interacts with nondeterminism; that is, the scores produced by a neural network determine the weights of one or more nondeterministic choices, while the choice or choices made determine the network's or computation's architecture or flow. This differs from the conventional use of computation graphs, which are based on a predefined architecture. In conventional cases, the graph is fixed in advance by an engineer and the training process learns the values of parameters in that structure. This conventional approach differs from implementations of the embodiments described herein, as in these cases the structure of the graph changes in response to one or more of the previous steps executed.

As with probabilistic programs, various inference algorithms can be applied to a program or computation sketch. Furthermore, a sketch's neural network parameters can be estimated by use of standard optimization methods, specifically optimization methods of the types used to minimize an objective or training function (such as to minimize a difference between outputs of a model and a comparison value). The inventors note that this can be done by using stochastic gradient descent (SGD) from either input/output examples or full execution traces, but that the inventive methods are not limited to using SGD as an optimization method, and can in most cases use any suitable gradient optimization method used in neural network development, such as Adadelta or ADAM.

As further described in the Appendix to the provisional patent application from which this application claims priority, the inventors have evaluated the inventive approach on a challenging diagram question answering task, which recent work has demonstrated can be formulated as learning to execute a certain class of probabilistic programs. On this task, the inventors found that the enhanced modeling power of neural networks improves accuracy. Embodiments of the apparatus, methods, and systems described herein may be used to provide this capability, as well as other advantages and benefits.

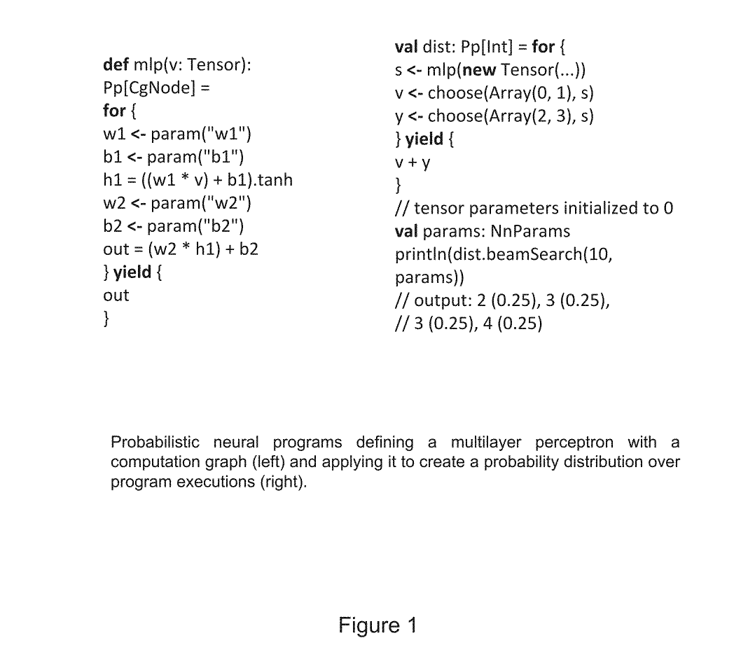

FIG. 1 is a diagram illustrating a multilayer perceptron (MLP) defined as a probabilistic neural program. Note that this definition resembles those of other computation graph frameworks; network parameters and intermediate values are represented as computation graph nodes with tensor values. The network parameters determine how an output is produced from the input data. As tensors, these parameters and values can be manipulated with standard operations, such as matrix-vector multiplication and hyperbolic tangent. Because tensors can be subject to the operations used to implement a neural network (e.g., a MLP), this enables a MLP (and possibly other forms of a neuron or neural network) to be inserted into a computation graph as a form of operator. Evaluating the function defined in FIG. 1 with a tensor yields a program sketch object that can be evaluated using a set of network parameters to produce the network's (MLP's) output.

As mentioned, probabilistic neural programs as described herein build on computation graph frameworks for specifying neural networks, by adding an operator for nondeterministic choice. The inventors have developed a Scala programming language library for probabilistic neural programming that may be used to illustrate some of the key concepts described herein. Further information may be found at https://github.com/allenai/pnp, which contains information regarding the implementation and operation of one or more of the embodiments described herein, and which is incorporated by reference in its entirety (as well as being referenced in the provisional patent application from which the present application claims priority).
FIG. 1 (left column) defines a multilayer perceptron as a probabilistic neural program. As mentioned, this definition resembles those of other computation graph frameworks, with network parameters and intermediate values represented as computation graph nodes with tensor values. Evaluating this function with a tensor yields a program sketch object that can be evaluated with a set of network parameters to produce the network's output;
FIG. 1 (right column) shows how to use the innovative “choose” function to create a nondeterministic choice. This function non-deterministically selects a value from a set or list of options. The “score” associated with each option is given by the value of a computation graph node that has the same number of elements as the list. The choose function or operator is a new type of node that determines which node will come next in the computation;
   Evaluating this function with a tensor yields a program sketch object that represents a function from neural network parameters to a probability distribution over values. The log probability of a value is proportional to the sum of the scores of the choices made in the execution that produced it;
   Performing (approximate) inference over this object—in this case, using a beam search technique—produces an explicit representation of the distribution;
   Multiple nondeterministic choices can be combined to produce more complex sketches; this capability can be used to define complex computational models, including general-purpose models such as Turing machines. The Scala library referred to also contains functions for conditioning on observations.

Note that although various inference algorithms may be applied to a program sketch, in this example the inventors used a simple beam search over executions. This approach is in accord with the recent trend in structured prediction to combine greedy inference or beam search with powerful non-factoring models. The beam search maintains a queue of partial program executions, each of which is associated with a score. Each step of the search continues each execution until it encounters a call to “choose”, which adds zero or more executions to the queue for the next search step. The lowest scoring executions are discarded to maintain a fixed beam width. As an execution proceeds, it may generate new computation graph nodes; the search maintains a single computation graph shared by all executions to which these nodes are added. The search simultaneously performs the forward pass over these nodes as necessary to compute scores for future choices.

The neural network parameters are trained to maximize the log-likelihood of correct program executions using stochastic gradient descent (or a similar method). Each training example consists of a pair of program sketches, representing an unconditional and a conditional distribution. The gradient computation is similar to that of a log-linear model with neural network factors. The computation first performs inference on both the conditional and unconditional distributions to estimate the expected counts associated with each nondeterministic choice; these counts are then back-propagated through the computation graph to update the network parameters.

As described, FIG. 1 shows how to use the “choose” function to create a nondeterministic choice. This function non-deterministically selects a value from a list of options. This choice creates a nondeterministic branch in the program execution flow, which is a fundamental part of probabilistic programming. The score of each option is given by the value of a computation graph node that has the same number of elements as the list, which corresponds to a branch in the program execution flow. These scores can be specified manually, they can be learned, or they can be specified by some combination of manual inputs and learning, during an inference procedure using standard neural network methods, such as backwards-propagation.

Evaluating the “choose” function with a tensor yields a program sketch object that represents a function or representation from neural network parameters to a probability distribution over values. The log probability of a value is proportional to the sum of the scores of the choices made in the execution path that produced it. Performing (approximate) inference over this object—in this case, using beam search—produces an explicit representation of the distribution, and therefore an explicit representation of potential program executions.

As mentioned, multiple nondeterministic choices can be combined to produce more complex program sketches; this capability can be used to define relatively complex computational models, including general-purpose models such as Turing machines. The Scala library referred to (which was created by the inventors) also has functions for conditioning an execution path based on observations. Note that the non-determinism in the probabilistic programming (the “choose” function), is derived from a neural network, which is one way in which the embodiments described herein may be differentiated from conventional approaches.

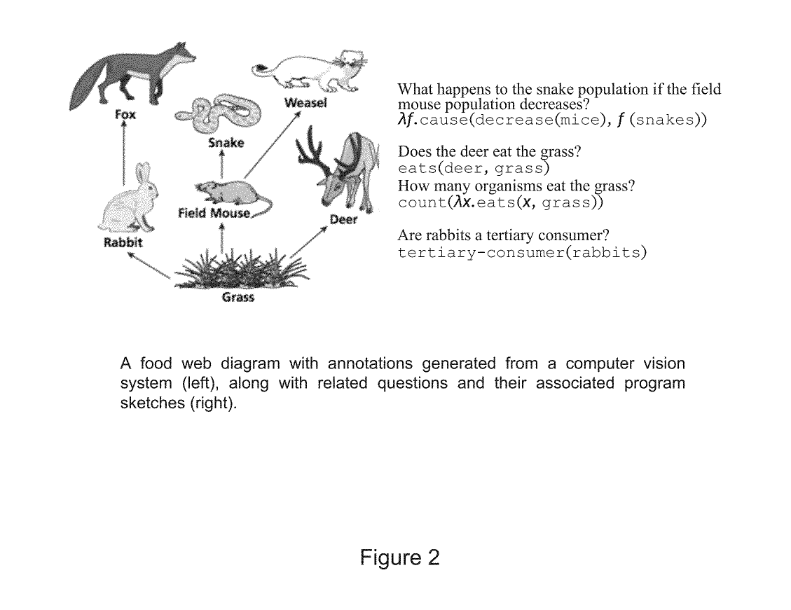

FIG. 2 is a diagram illustrating a food web with annotations generated from a computer vision system (left), along with related questions and their associated program sketches (right), and represents an example problem or task to which the inventive approach has been applied. Using FIG. 2, the inventors considered the problem of learning to execute program sketches in a food web computational model using visual information from a diagram. This problem or task was motivated by recent work, which demonstrated that diagram question answering can be formulated as translating natural language questions to program sketches in this model, then learning to execute these sketches.

FIG. 2 shows some example questions from this work, along with the accompanying diagram that is interpreted to determine the answers. The diagram (left side) is a food web, which depicts a collection of organisms in an ecosystem with arrows to indicate what each organism eats. The right side of the figure shows questions pertaining to the diagram and their associated program sketches (e.g., λf. cause(decrease (mice), f (snakes)).

The possible executions of each program sketch are determined by a domain-specific computational model that is designed to reason about food webs. The nondeterministic choices in the model correspond to information that must be extracted from the diagram. Specifically, there are two functions that “call” the “choose” operation or function to non-deterministically return a Boolean value. The first calling function, organism (x), should return “true” if the text label x is an organism (as opposed to e.g., the image title). The second calling function, eat (x, y), should return “true” if organism x eats organism y. Note that these functions influence program control flow, as the returned value of the function determines how the code branches. The food web model may also include other functions, e.g., for reasoning about population changes, that call “organism” and “eat” to extract information or identify relationships from the diagram (where the arrows represent the act of eating and the organisms connected by the arrows represent the eating organism and the eaten organism).

The inventors considered three models for learning to make the choices for the functions “organism” and “eat”: a non-neural (Log-Linear) model, as well as two probabilistic neural models (2-Layer PNP and Maxpool PNP). All three approaches (i.e., log-linear and probabilistic neural models) learn models for both the “organism” and “eat” functions using outputs from a computer vision system trained to detect organism, text, and arrow relations between them. This system and its characteristics are described in detail in the article by Jayant Krishnamurthy, Oyvind Tafjord, and Aniruddha Kembhavi entitled Semantic parsing to probabilistic programs for situated question answering. EMNLP, 2016. The article includes a definition of a set of hand-engineered features heuristically created from the outputs of the vision system.

The non-neural Log-Linear and neural 2-Layer PNP models use only these features, and the difference between the results is due to the greater expressivity of a two-layer neural network. However, one of the major strengths of neural models is their ability to learn latent feature representations automatically, and the third model (Maxpool PNP) also uses the direct outputs of the vision system not made into features. The architecture of Maxpool PNP reflects this and contains additional input layers that perform a max pooling operation over detected relationships between objects and confidence scores. The inventors expect that their neural network modeling of nondeterminism will learn better latent representations than the manually defined features.

Note that although portions of the descriptions of the embodiments of the inventive system and methods relied on the use of Boolean operations (T/F), the methods and approaches described herein are applicable for use with any multivariate class that is used to describe the outputs. In terms of implementation, the change for a multivariate class of size n would be that the “choose” function has up to n possible return values instead of 0-1. These in turn could allow for the execution to branch in n different ways. This is akin to the superset representation of the multivariate or categorical distributions in relation to the Bernoulli distribution.

As described further in the Appendix to the provisional patent application from which this application claims priority, the inventors evaluated the performance of their probabilistic neural approach to program induction using the food web model and dataset referred to with regards to the description of FIG. 2. This evaluation confirmed the utility and effectiveness of the approach developed by the inventors.

More specifically, the inventors evaluated an embodiment of the probabilistic neural programs described herein on the FOODWEBS dataset introduced by the article “Semantic parsing to probabilistic programs for situated question answering” referred to previously. This dataset contains a training set of ˜2,900 programs and a test set of ˜1,000 programs. These programs are human annotated gold standard interpretations for the questions in the dataset, which corresponds to assuming that the translation from questions to programs is perfect. The probabilistic neural programs described herein are trained using correct execution traces of each program, which are also provided in the dataset.

The models' performance were evaluated using two metrics. First, execution accuracy measures the fraction of programs in the test set that are executed completely correctly by the model. This metric is challenging because correctly executing a program requires correctly making a number of “choose” decisions. The 1,000 test programs contained over 35,000 decisions, implying that to completely execute a program correctly means getting, on average, 35 “choose” decisions correct without making any mistakes. Second, “choose” accuracy measures the accuracy of each decision independently, assuming all previous decisions were made correctly.

Table 1 (below) compares the accuracies of the three models based on their performance on the FOODWEBS dataset. The improvement in accuracy between the baseline (Log-Linear) and the probabilistic neural program (2-Layer PNP) is believed due to the neural network's enhanced modeling power. Though the “choose” accuracy does not improve by a large margin, the improvement translates into large gains in correctness of the entire program. Finally, as expected, the inclusion of lower level features (Maxpool PNP) not possible in the Log-Linear model significantly improves the performance. Note that this task requires performing computer vision, and thus it is not expected that any model will be able to achieve 100% accuracy.

TABLE 1

| | Execution | “choose” |
|---|---|---|
| Method | Accuracy | Accuracy |
| LOGLINEAR | 8.6% | 78.2% |
| 2-LAYER PNP | 12.5% | 78.7% |
| MAXPOOL PNP | 14.9% | 82.5% |

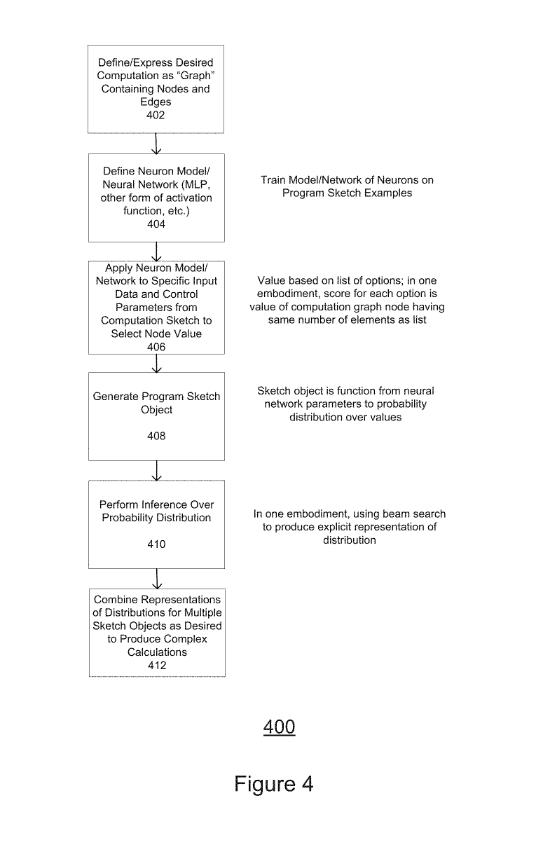

FIG. 4 is a flowchart or flow diagram illustrating a process, method, or sequence of operations 400 for implementing an embodiment of the inventive system and method. As shown in the figure, a desired computation or sequence of computations (which may include functions, operations, etc.) is expressed as a computation graph in the form of nodes and edges (as suggested by step or stage 402). A neuron/neural network “model” is selected or defined (in one example embodiment, a multi-layer perceptron (MLP)), as suggested by step or stage 404. The neural network is trained using pairs of conditional and unconditional program sketch examples. The neuron model/network is then applied to specific data and (if desired) control parameters from a computation sketch to generate/select a value for a node (as suggested by step or stage 406). The result is used to generate a program sketch object (step or stage 408). An inference methodology is then used to produce an explicit representation of the distribution of values generated by the sketch object function in step or stage 408 (as suggested by step or stage 410). The explicit representations from multiple sketch objects may then be combined to create more complex calculations (step or stage 412).

This application describes the inventors' concepts and implementation of an embodiment or embodiments of probabilistic neural programs, a framework for program induction that permits flexible specification of computational models and inference algorithms, while simultaneously enabling the use of deep learning architectures. In some embodiments, a program sketch describes a collection of nondeterministic decisions to be made during execution, along with the neural architecture to be used for scoring these decisions. The network parameters of a sketch can be trained from data using any standard deep learning inference method, such as, but not limited to, stochastic gradient descent (as noted previously, other optimization methods may also or instead be used). The inventors have demonstrated that probabilistic neural programs improve accuracy on a diagram question-answering task that can be formulated as a task of learning to execute program sketches in a domain-specific computational model.

As noted, in some embodiments, the system and methods described herein may be implemented in the form of an apparatus that includes a processing element and a set of executable instructions. The executable instructions may be part of a software application and arranged into a software architecture. In general, an embodiment may be implemented using a set of software instructions that are designed to be executed by a suitably programmed processing element (such as a CPU, graphics processing unit (GPU), microprocessor, processor, controller, computing device, etc.). In a complex application or system, such instructions are typically arranged into “modules” with each such module typically performing a specific task, process, function, or operation. The set of modules may be controlled or coordinated in their operation by an operating system (OS) or other form of organizational platform.

The application modules and/or sub-modules may include any suitable computer-executable code or set of instructions (e.g., as would be executed by a suitably programmed processor, microprocessor, GPU, or CPU), such as computer-executable code corresponding to a programming language. For example, programming language source code may be compiled into computer-executable code. Alternatively, or in addition, the programming language may be an interpreted programming language such as a scripting language.

Each application module or sub-module may correspond to a particular function, method, process, or operation that is implemented by the module or sub-module. Such function, method, process, or operation may include those used to implement one or more aspects or embodiments of the system and methods described herein, such as for:
object Pnp—entry point for probabilistic neural programming (PNP) code
CategoricalPnp[A]—method to return a non-deterministic choice of an element in a distribution
ScorePnp—method to score the neural program at the current step
SamplePNP—method to sample from the distribution
class ComputationGraphPnp( )—class to define a computation graph using probabilistic neural programs
partitionFunction( )—method for normalizing probabilities in a probabilistic neural program.
Choose( )—function inherent in probabilistic programming that is extended to use in neural networks
Parameters—parameters from a standard neural network definition
Computation Graph—a representation of a neural network in a computation graph framework
Beam Search—a search for possible executions, storing only k highest scoring results at a given step (standard in many NP-hard problems)
   Note that the web-page found at (https://github.com/allenai/pnp, some of the contents of which is found in the included Appendix) provides further details regarding the Scala library developed by the inventors for purposes of implementing the various embodiments of the invention described herein.

For further implementation details, some example sub-routines are listed below, with others being available as described in the provisional patent application from which this application claims priority, or from the website referred to previously.

```
object Pnp {
  /** Create a program that returns {@code value}
    */
  def value[A](value: A): Pnp[A] = { ValuePnp(value) }
  /** A nondeterministic choice. Creates a program
    * that chooses and returns a single value from
    * {@code dist} with the given probability.
    */
  def chooseMap[A](dist: Seq[(A, Double)]): Pnp[A] = {
    CategoricalPnp(dist.map(x => (x._1, Math.log(x._2))).toArray, null)
  }
  def choose[A](items: Seq[A], weights: Seq[Double]): Pnp[A] = {
    CategoricalPnp(items.zip(weights).map(x => (x._1, Math.log(x._2))).toArray, null)
  }
  def choose[A](items: Seq[A]): Pnp[A] = {
    CategoricalPnp(items.map(x => (x, 0.0)).toArray, null)
  }
  def chooseTag[A](items: Seq[A], tag: Any): Pnp[A] = {
    CategoricalPnp(items.map(x => (x, 0.0)).toArray, tag)
  }
  /** The failure program that has no executions.
    */
  def fail[A]: Pnp[A] = { CategoricalPnp(Array.empty[(A, Double)], null) }
  def require(value: Boolean): Pnp[Unit] = {
    if (value) {
      Pnp.value(( ))
    } else {
      Pnp.fail
    }
}
def searchStep[B](env: Env, logProb: Double, context: PnpInferenceContext,
      continuation: PnpContinuation[A, B], queue: PnpSearchQueue[B],
      finished: PnpSearchQueue[B]): Unit = {
    if (items.size > 0) {
      val (paramTensor, numTensorValues) = getTensor(context.compGraph)
      val v = paramTensor.toVector
      for (i <- 0 until numTensorValues) {
        val nextEnv = env.addLabel(parameter, i)
        val nextLogProb = logProb + v(i)
        queue.offer(BindPnp(ValuePnp(items(i)), continuation), nextEnv, nextLogProb, context,
          tag, items(i))
      }
class ScorePnp(score: Double) extends Pnp[Unit] {
  override def searchStep[C](env: Env, logProb: Double, context: PnpInferenceContext,
continuation: PnpContinuation[Unit,C],
    queue: PnpSearchQueue[C], finished: PnpSearchQueue[C]): Unit = {
    // TODO(joelgrus) should we be taking log here?
    val nextLogProb = logProb + Math.log(score)
    continuation.searchStep(( ), env, nextLogProb, context, queue, finished)
  }
// Classes for representing computation graph elements.
case class ComputationGraphPnp( ) extends Pnp[CompGraph] {
  override def searchStep[C](env: Env, logProb: Double, context: PnpInferenceContext,
continuation: PnpContinuation[CompGraph,C],
    queue: PnpSearchQueue[C], finished: PnpSearchQueue[C]): Unit = {
    continuation.searchStep(context.compGraph, env, logProb, context, queue, finished)
  }
  override def sampleStep[C](env: Env, logProb: Double, context: PnpInferenceContext,
continuation: PnpContinuation[CompGraph,C],
    queue: PnpSearchQueue[C], finished: PnpSearchQueue[C]): Unit = {
    continuation.sampleStep(context.compGraph, env, logProb, context, queue, finished)
```

As described herein, the inventors have developed probabilistic neural programs, a framework for program induction that permits flexible specification of the computational model and inference algorithm while simultaneously enabling the use of deep neural networks. The approach builds on computation graph frameworks for specifying neural networks by adding an operator for weighted nondeterministic choice that operates to specify the computational model. Thus, a program sketch describes both the decisions to be made and the architecture of the neural network used to score the decisions. Further, the computation graph interacts with nondeterminism: the scores produced by the neural network determine the weights of nondeterministic choices, while the choices determine the network's architecture. As with probabilistic programs, various inference algorithms can be applied to a sketch. Furthermore, a sketch's neural network parameters can be estimated using stochastic gradient descent (or other optimization method) from either input/output examples or full execution traces.

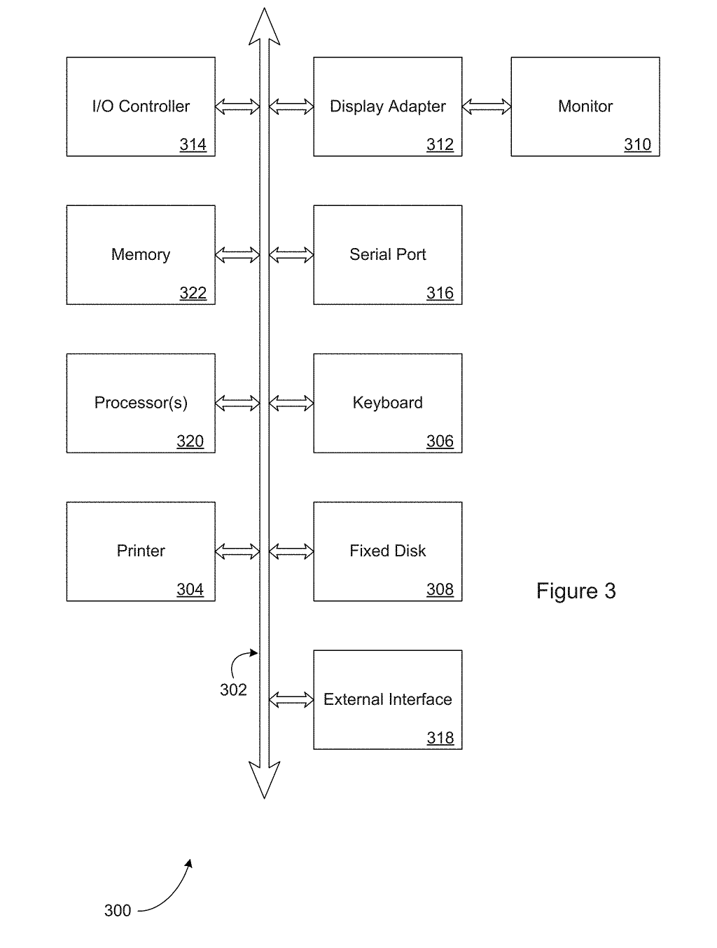

As noted, the system, apparatus, methods, processes, functions, and/or operations for implementing an embodiment of the invention may be wholly or partially implemented in the form of a set of instructions executed by one or more programmed computer processors such as a central processing unit (CPU), GPU, or microprocessor. Such processors may be incorporated in an apparatus, server, client or other computing or data processing device operated by, or in communication with, other components of the system. As an example, FIG. 3 is a diagram illustrating elements or components that may be present in a computer device or system 300 configured to implement a method, process, function, or operation in accordance with an embodiment of the invention. The subsystems shown in FIG. 3 are interconnected via a system bus 302. Additional subsystems include a printer 304, a keyboard 306, a fixed disk 308, and a monitor 310, which is coupled to a display adapter 312. Peripherals and input/output (I/O) devices, which couple to an I/O controller 314, can be connected to the computer system by any number of means known in the art, such as a serial port 316. For example, the serial port 316 or an external interface 318 can be utilized to connect the computer device 300 to further devices and/or systems not shown in FIG. 3 including a wide area network such as the Internet, a mouse input device, and/or a scanner. The interconnection via the system bus 302 allows one or more processors 320 to communicate with each subsystem and to control the execution of instructions that may be stored in a system memory 322 and/or the fixed disk 308, as well as the exchange of information between subsystems. The system memory 322 and/or the fixed disk 308 may embody a tangible computer-readable medium.

It should be understood that the embodiments as described above can be implemented in the form of control logic using computer software in a modular or integrated manner. Based on the disclosure and teachings provided herein, a person of ordinary skill in the art will know and appreciate other ways and/or methods to implement the embodiments using hardware and a combination of hardware and software.

Any of the software components, processes or functions described in this application may be implemented as software code to be executed by a processor using any suitable computer language such as, for example, Java, JavaScript, C++ or Perl using, for example, conventional or object-oriented techniques. The software code may be stored as a series of instructions, or commands in or on a non-transitory computer readable medium (i.e., any suitable medium or technology with the exception of a transitory waveform), such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

Embodiments of the invention may be implemented in whole or in part as a system, as one or more methods, or as one or more devices. Embodiments of the invention may take the form of a hardware implemented embodiment, a software implemented embodiment, or an embodiment combining software and hardware aspects. For example, as noted in some embodiments, one or more of the operations, functions, processes, or methods described herein may be implemented by one or more suitable processing elements (such as a processor, microprocessor, CPU, GPU, controller, etc.) that is part of a client device, server, network element, or other form of computing or data processing device/platform and that is programmed with a set of executable instructions (e.g., software instructions), where the instructions may be stored in a suitable data storage element (for example, a non-transitory computer readable medium, examples of which are provided herein). In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or any other suitable form.

According to one example implementation, the term device or computing device, as used herein, may be a CPU, or conceptualized as a CPU (such as a virtual machine). In this example implementation, the computing device (CPU) may be coupled, connected, and/or in communication with one or more peripheral devices, such as display. In another example implementation, the term computing device, as used herein, may refer to a mobile computing device, such as a smartphone or tablet computer. In this example embodiment, the computing device may output content to its local display and/or speaker(s). In another example implementation, the computing device may output content to an external display device (e.g., over Wi-Fi) such as a TV or an external computing system.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM.

In general, a non-transitory computer-readable medium may comprise or encompass almost any type of medium on (or in) which data may be stored, with the exception of a waveform or similar transitory phenomena. Such computer readable storage media allow the device to access computer-executable process steps, application programs and the like, stored on removable and non-removable memory media, to off-load data from the device or to upload data onto the device. A computer program product, such as one utilizing a communication system may be tangibly embodied in storage medium, which may comprise a machine-readable storage medium.

As noted, in example implementations of the disclosed technology, the computing device may include any number of hardware and/or software applications that are executed to facilitate any of the operations. In example implementations, one or more I/O interfaces may facilitate communication between the computing device and one or more input/ output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various implementations of the disclosed technology and/or stored in one or more memory devices.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the invention.

### Appendix

### Probabilistic Neural Programs (PNP)

As mentioned, Probabilistic Neural Programming (PNP) is a Scala library developed by the inventors for expressing, training and running inference in neural network models that include discrete choices. The enhanced expressivity of PNP is useful for structured prediction, reinforcement learning, and latent variable models.

Probabilistic neural programs have several advantages over computation graph libraries for neural networks, such as TensorFlow:
Probabilistic inference is implemented within the library. For example, running a beam search to (approximately) generate the highest-scoring output sequence of a sequence-to-sequence model takes 1 line of code in PNP.
Additional training algorithms that require running inference during training are part of the library. This includes learning-to-search algorithms, such as LaSO, reinforcement learning, and training latent variable models.
Computation graphs are a subset of probabilistic neural programs. We use DyNet to express neural networks, which provides a rich set of operations and efficient training.

### Installation

This library depends on DyNet with the Scala DyNet bindings. See the link for build instructions. After building this library, run the following commands from the pnp root directory:

cd lib
In -s <PATH_TO_DYNET>/build/contrib/swig/dynet_swigJNI_scala.jar .
In -s <PATH_TO_DYNET>/build/contrib/swig/dynet_swigJNI_dylib.jar .

### Usage

This section describes how to use probabilistic neural programs to define and train a model. The typical usage has three steps:
1. Define a model. Models are implemented by writing a function that takes your problem input and outputs Pnp[X] objects. The probabilistic neural program type Pnp[X] represents a function from neural network parameters to probability distributions over values of type X. Each program describes a (possibly infinite) space of executions, each of which returns a value of type X.
2. Train. Training is performed by passing a list of examples to a Trainer, where each example consists of a Pnp[X] object and a label. Labels are implemented as functions that assign costs to program executions or as conditional distributions over correct executions. Many training algorithms can be used, from loglikelihood to learning-to-search algorithms.
3. Run the model. A model can be run on a new input by constructing the appropriate Pnp[X] object, then running inference on this object with trained parameters.

### Defining Probabilistic Neural Programs

Probabilistic neural programs are specified by writing the forward computation of a neural network, using the choose operation to represent discrete choices. Roughly, we can write:

```
val pnp = for {
  scores1 <- ... some neural net operations ...
  // Make a discrete choice
  x1 <- choose(values, scores1)
  scores2 <- ... neural net operations, may depend on x1 ...
  ...
  xn <- choose(values, scoresn)
} yield {
  xn
}
```

pnp then represents a function that takes some neural network parameters and returns a distribution over possible values of xn (which in turn depends on the values of intermediate choices). We evaluate pnp by running inference, which simultaneously runs the forward pass of the network and performs probabilistic inference:

nnParams = ...
val dist = pnp.beamSearch(10, nnParams)

### Choose Operator/Function/Node

The choose operator defines a distribution over a list of values:

val flip: Pnp[Boolean]=choose(Array(true, false), Array(0.5, 0.5))

This snippet creates a probability distribution that returns either true or false with 50% probability. flip has type Pnp[Boolean], which represents a function from neural network parameters to probability distributions over values of type Boolean. (In this case it's just a probability distribution since we haven't referenced any parameters.) Note that flip is not a draw from the distribution, rather, it is the distribution itself. The probability of each choice can be given to choose either in an explicit list (as above) or via an Expression of a neural network.

We compose distributions using for { . . . } yield { . . . }:

```
val twoFlips: Pnp[Boolean] = for {
  x <- flip
  y <- flip
} yield {
  x && y
}
```

This program returns true if two independent draws from flip both return true. The notation x<-flip can be thought of as drawing a value from flip and assigning it to x. However, we can only use the value within the for/yield block to construct another probability distribution. We can now run inference on this object:

val marginals3 = twoFlips.beamSearch(5)
printIn(marginals3.marginals( ).getProbabilityMap)

This prints out the expected probabilities:

{false=0.75, true=0.25}

### Neural Networks

Probabilistic neural programs have access to an underlying computation graph that is used to define neural networks:

```
def mlp(x: FloatVector): Pnp[Boolean] = {
  for {
    // Get the computation graph
    cg <- computationGraph( )
    // Get the parameters of a multilayer perceptron by name.
    // The dimensionalities and values of these parameters are
    // defined in a PnpModel that is passed to inference.
    weights1 <- param(″layer1Weights″)
    bias1 <- param(″layer1Bias″)
    weights2 <- param(″layer2Weights″)
    // Input the feature vector to the computation graph and
    // run the multilayer perceptron to produce scores.
    inputExpression = input(cg.cg, Seq(FEATURE_VECTOR_DIM), x)
    scores = weights2 * tanh((weights1 * inputExpression) + bias1)
    // Choose a label given the scores. Scores is expected to
    // be a 2-element vector, where the first element is the score
    // of true, etc.
    y <- choose(Array(true, false), scores)scores)
  } yield {
    y
  }
}
```

We can then evaluate the network on an example:

val model = PnpModel.init(true)
// Initialize the network parameters. The values are
// chosen randomly.
model.addParameter(″layer1Weights″, Seq(HIDDEN_DIM, FEATURE_
VECTOR_DIM))
model.addParameter(″layer1Bias″, Seq(HIDDEN_DIM))
model.addParameter(″layer2Weights″, Seq(2, HIDDEN_DIM))
// Run the multilayer perceptron on featureVector
val featureVector = new FloatVector(Seq(1.0f, 2.0f, 3.0f))
val dist = mlp(featureVector)
val marginals = dist.beamSearch(2, model)
for (x <- marginals.executions) {
printIn(x)
}

This prints something like:

[Execution true-0.4261836111545563]

[Execution false-1.058420181274414]

Each execution has a single value that is an output of our program and a score derived from the neural network computation. In this case, the scores are log probabilities, but the scores may have different semantics depending on the way the model is defined and its parameters are trained.

Pnp uses Dynet as the underlying neural network library, which provides a rich set of operations (e.g., LSTMs).

That which is claimed is:

1. A method for generating a computation graph describing a computation, the method comprising:
representing the computation by a set of graph nodes and edges, wherein each graph node is associated with a corresponding value and each edge represents a relationship between a pair of nodes;
using an operator to determine a value in the computation graph, wherein the operator performs a nondeterministic operation that is implemented at least in part by a neural network; and
storing a representation of the computation graph in an electronic data storage element.

2. The method of claim 1, wherein the nondeterministic operation is one that selects between two or more options for the computation based on a score associated with each option, and further, wherein the score is determined by the neural network.

3. The method of claim 2, wherein the operator is a choose function, the choose function operating to determine the value by selecting between the two or more options.

4. The method of claim 3, wherein the score represents a weight associated with a choice.

5. The method of claim 4, wherein the score is a value of a computation graph node that has the same number of elements as the two or more options.

6. The method of claim 1, further comprising:
providing an input to the generated computation graph; and
using the computation graph to generate an output corresponding to the provided input.

7. The method of claim 6, wherein the input is a representation of an image.

8. The method of claim 4, further comprising applying an inference algorithm to the computation graph and using the output of applying the inference algorithm to determine the score associated with an option.

9. The method of claim 1, further comprising evaluating the operator with a tensor to generate a program sketch object that represents a function from the neural network parameters to a probability distribution over values.

10. An apparatus for generating a computation graph for a computation, comprising:
a processor programmed to execute a set of instructions;
a data storage element in which the set of instructions are stored, wherein when executed by the processor the set of instructions cause the apparatus to
represent the computation by a set of graph nodes and edges, wherein each graph node is associated with a corresponding value and each edge represents a relationship between a pair of nodes;
use an operator to determine a value in the computation graph, wherein the operator performs a nondeterministic operation that is implemented at least in part by a neural network; and
store a representation of the computation graph in an electronic data storage element.

11. The apparatus of claim 10, wherein the nondeterministic operation is one that selects between two or more options for the computation based on a score associated with each option, and further, wherein the score is determined by the neural network.

12. The apparatus of claim 11, wherein the added operator is a choose function, the choose function operating to determine the value by selecting between the two or more options.

13. The apparatus of claim 12, wherein the score represents a weight associated with a choice.

14. The apparatus of claim 12, wherein the score is a value of a computation graph node that has the same number of elements as the two or more options.

15. The apparatus of claim 10, further comprising instructions that cause the apparatus to:
receive an input to the generated computation graph; and
use the computation graph to generate an output corresponding to the input.

16. The apparatus of claim 15, wherein the input is a representation of an image.

17. The apparatus of claim 13, further comprising instructions that cause the apparatus to apply an inference algorithm to the computation graph and use the output of applying the inference algorithm to determine the score associated with an option.

18. The apparatus of claim 10, further comprising instructions that cause the apparatus to evaluate the operator with a tensor to generate a program sketch object that represents a function from the neural network parameters to a probability distribution over values.
